(19) United States
(12) Patent Application Publication
(10) Pub. No.: US 2009/0001234 A1
(43) Pub. Date: Jan. 1, 2009

(54) Segregator Barriers

(75) Inventors: John A. Fullagar, Kent (GB); Andrew J. Cuthbertson, Kent (GB); Reginald J. Woods, Hampshire (GB)

Correspondence Address: KLEIN, O'NEILL & SINGH, LLP, 43 CORPORATE PARK, SUITE 204, IRVINE, CA, 92606, US

(73) Assignee: Livis Limited

(21) Appl. No.: 12/279,954

(22) PCT Filed: Feb. 21, 2007
(86) PCT No.: PCT/GB2007/000603

§ 371 Date: Aug. 19, 2008

(30) Foreign Application Priority Data
Feb. 22, 2006 (GB) 0603579.4

(51) Int. Cl. F16B 47/00; E01F 13/02

(52) U.S. Cl. 248/205.9

(57) ABSTRACT

A segregator barrier (2) comprising a barrier portion attached to one or more suction plates (4), wherein the or each suction plate (4) is operable to adhere to a surface by means of a vacuum created between the surface and the suction plate (4), wherein in use the vacuum is provided by a vacuum source. One or more one-way flow valves may be provided between the vacuum source and the suction plate (4) or at least one of the suction plates (4). Furthermore, one or more vacuum reservoirs may be provided between the vacuum source and the suction plate (4) or at least one of the suction plates (4). The barrier (2) may also be adapted to mitigate the effect of a shock load applied to the barrier.

The present invention relates to segregator barriers and to means for securing segregator barriers to a fixed surface, particularly but not exclusively for use in securing safety barriers to a railway platform during maintenance work.

### BACKGROUND

Typically segregator barriers act as dividers, either separating people from danger (e.g. a vertical drop) or from each other (e.g. in crowd control situations). In many of these applications safety is paramount, yet often such barriers are only required on a temporary basis. By way of example, WO2006/135550 discloses a semi-permanent barrier system for the edge of a roof, which folds away flat when not in use. One particularly demanding application for segregator barriers is in the railway industry, where barriers are required to protect passengers or maintenance workers from a platform edge. For example, during maintenance work on a train station platform, a segregator barrier can separate workers from a passing train and it can also serve to protect the train from any resulting debris. A segregator barrier can therefore allow the railway line to remain open whilst maintenance work is carried out, thereby minimising any disruption to the rail network.

However, not only must such segregator barriers comply with stringent safety requirements, but they must also be quick and easy to erect, as station closures are often strictly limited in duration (particularly on busy commuter routes). Furthermore, segregator barriers used on platform edges operate in confined spaces (particularly in subterranean stations) and should not restrict the maintenance work to be carried out.

Existing segregator barriers often comprise scaffolding frames that are well-known in the art, however, these barriers are slow to erect and dismantle, thereby reducing valuable maintenance time. Other barrier solutions for station platforms exist; for example, WO00/17028 and GB2291034 both propose solutions. However, these systems are difficult to retrofit, expensive to implement and require closure of the railway line to install.

Ideally a barrier system that is safe, cheap and quick to erect or dismantle is required. In this regard, DE19630211, which discloses a barrier system with suction pads securing the barrier to the floor of a sports hall, offers a potential solution. However, such a barrier system is not sufficiently safe to be used in a hazardous environment and the present invention therefore addresses this issue.

### STATEMENTS OF INVENTION

According to the present invention, there is provided a segregator barrier comprising a barrier portion attached to one or more suction plates, wherein the or each suction plate is operable to adhere to a surface by means of a vacuum created between the surface and the suction plate, wherein in use the vacuum is provided by a vacuum source, and one or more one-way flow valves are provided between the vacuum source and the suction plate or at least one of the suction plates.

According to another aspect of the present invention, there is provided a segregator barrier comprising a barrier portion attached to one or more suction plates, wherein the or each suction plate is operable to adhere to a surface by means of a vacuum created between the surface and the suction plate, wherein in use the vacuum is provided by a vacuum source; and one or more vacuum reservoirs are provided between the vacuum source and the suction plate or at least one of the suction plates.

According to another aspect of the present invention, there is provided a segregator barrier comprising a barrier portion attached to one or more suction plates, wherein the or each suction plate is operable to adhere to a surface by means of a vacuum created between the surface and the suction plate, and wherein the barrier is adapted to mitigate the effect of a shock load applied to the barrier.

The segregator barrier may be provided with a manifold between the vacuum source and the suction plate or at least one of the suction plates.

The one or more one-way flow valves may be positioned between the manifold and the suction plate or at least one of the suction plates, and may be orientated to prevent flow from the manifold to the suction plate or at least one of the suction plates. The one or more one-way flow valves may be positioned between the vacuum source and the manifold and may-be orientated to prevent flow from the vacuum source to the manifold.

The one or more vacuum reservoirs may be positioned between the manifold and the suction plate or at least one of the suction plates. The one or more one-way flow valves may be positioned between the manifold and the one or more vacuum reservoirs.

The one or more vacuum reservoirs may be positioned between the vacuum source and the manifold. The one or more one-way flow valves may be positioned between the vacuum source and the one or more vacuum reservoirs. The one or more one-way flow valves may be positioned between the one or more vacuum reservoirs and the manifold.

The barrier may comprise a shock-reducing element for mitigating the effect of a shock load applied to the barrier and the barrier portion may comprise the shock-reducing element. The shock-reducing element may be provided between the barrier portion and the suction plate or at least one of the suction plates and the shock-reducing element may comprise a resilient element and/or a damping element.

An end of the shock-reducing element may be pivotally mounted on the suction plate or at least one of the suction plates and/or an end of the shock-reducing element may be pivotally mounted on the barrier portion. The barrier portion may be pivotally mounted on the suction plate or at least one of the suction plates.

The barrier portion may comprise a toe-board and the barrier portion may comprise infill panels and/or meshing.

The vacuum source may comprise a pump and the pump may be driven by an electric motor.

A fail-safe means may be provided; the fail-safe means comprising a detector which may be arranged to detect a loss of electrical power to the electric motor. The fail-safe means may further comprise a back-up battery, the back-up battery being arranged to provide the electric motor with electrical power when the fail-safe means detect a loss of electrical power to the motor.

An audible and/or visible alarm may be provided alerting a user to a failure of the vacuum source and a visible alarm may be provided for alerting a user to a loss of vacuum in the suction plate or at least one of the suction plates.

### BRIEF DESCRIPTION OF THE DRAWINGS

For a better understanding of the present invention, and to show more clearly how it may be carried into effect, reference will now be made, by way of example, to the following drawings, in which:

FIG. 1 shows a partial front view of a segregator barrier in accordance with an embodiment of the present invention;

FIG. 2 shows a full front view of a segregator barrier;

FIG. 3 shows a side view of a segregator barrier;

FIG. 4 shows, in side view, a range of possible positions for the segregator barrier;

FIG. 5 shows a plan view of a suction plate;

FIG. 6 shows a side view of a suction plate corresponding to section AA shown in FIG. 5;

FIG. 7 shows a side view of a suction plate corresponding to section BB shown in FIG. 5;

FIG. 8 shows a side view of a suction plate corresponding to section CC shown in FIG. 5;

FIGS. 9a and 9b show a side view and a plan view of a connecting part corresponding to detail A shown in FIG. 2;

FIG. 10 shows a side view of a toe-board arrangement corresponding to detail B shown in FIG. 3;

FIG. 11 shows a side view of a toe-board; and

FIG. 12 shows a schematic of the segregator barrier apparatus.

### DETAILED DESCRIPTION OF PREFERRED EMBODIMENT

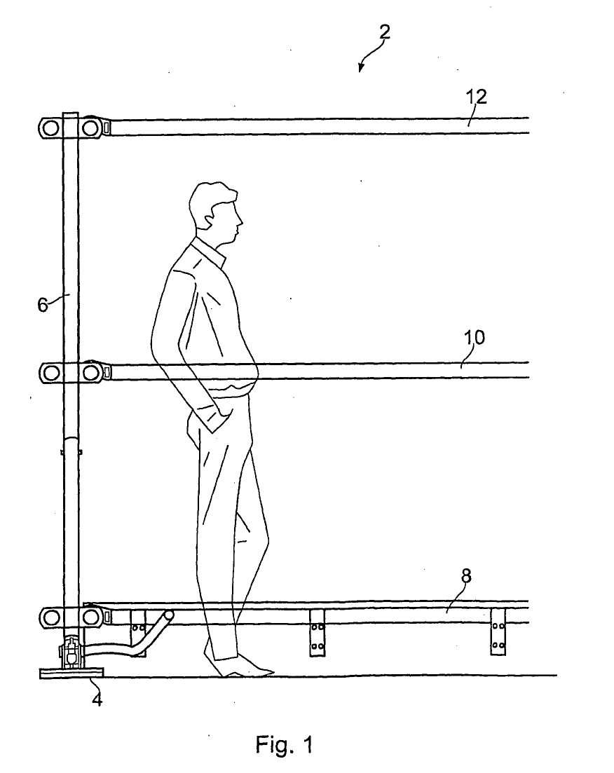

With reference to FIG. 1, a segregator barrier 2 comprises two suction plates 4 (only one of which is shown), two support members 6 (only one of which is shown) and first, second and third cross-bars 8, 10 and 12 respectively extending between the support members 6. The segregator barrier may comprise one or more cross-bars, which may or not be equally spaced apart. The cross bars 8, 10, 12 are joined at each end to one of the support members 6 which is in turn connected to one of the suction plates 4. In the embodiment shown, the cross-bars are substantially horizontal, however, in an alternative embodiment they may be diagonal. The suction plate 4 adheres to a surface (not shown) by virtue of a vacuum. The support member 6 is preferably taller than a typical person.

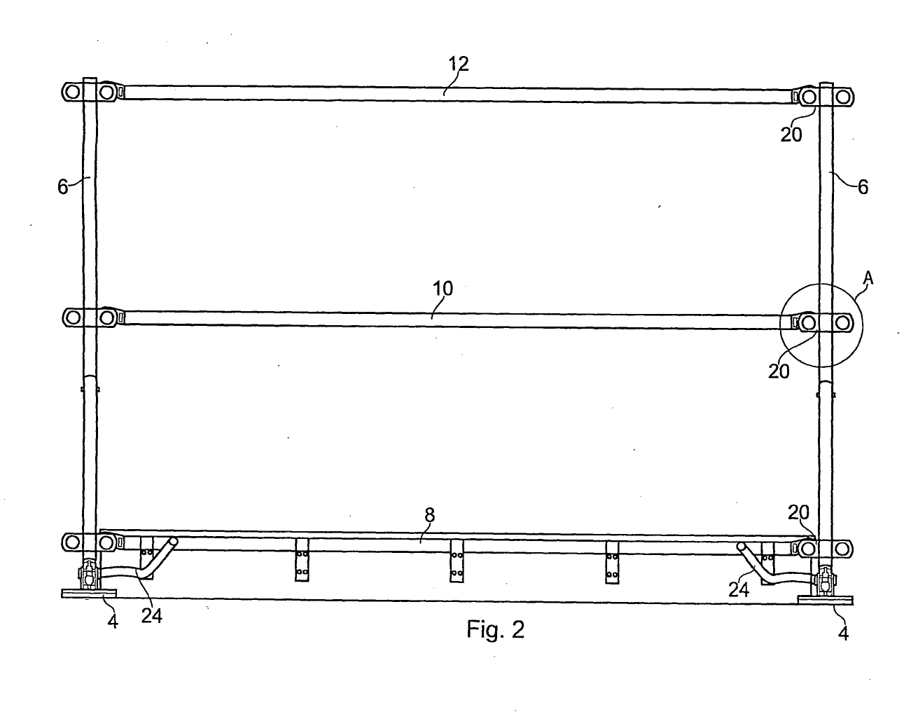

With reference to FIG. 2, a segregator barrier further comprises brackets 20. The brackets 20 provide a means for joining the first, second and third cross-bars 8, 10, 12 to the support member 6. In an alternative embodiment (not shown), the brackets 20 may be omitted and the cross-bars 8, 10, 12 may connect to the support member 6 directly. Infill panels or meshing (not shown) may stretch across the structure defined by the support member 6 and cross-bars 8, 10, 12. The meshing may comprise flame retardant netting, which allows a 60% air flow to minimise the risk of wind moving the barrier.

The segregator barrier 2 further comprises a toe-board 22. The toe board 22 is preferably connected to the first cross bar 8 and extends from the first cross bar 8 to the ground. The segregator barrier 2 also comprises hosing 24. The hosing 24 connects to each suction plate 4 thereby providing means for each suction plate 4 to be evacuated. The hosing 24 may pass through the first cross bar 8. The segregator barrier 2 shown in FIG. 2 may be successively repeated such that a continuous barrier with two or more support members 6 and suction plates 4 are provided.

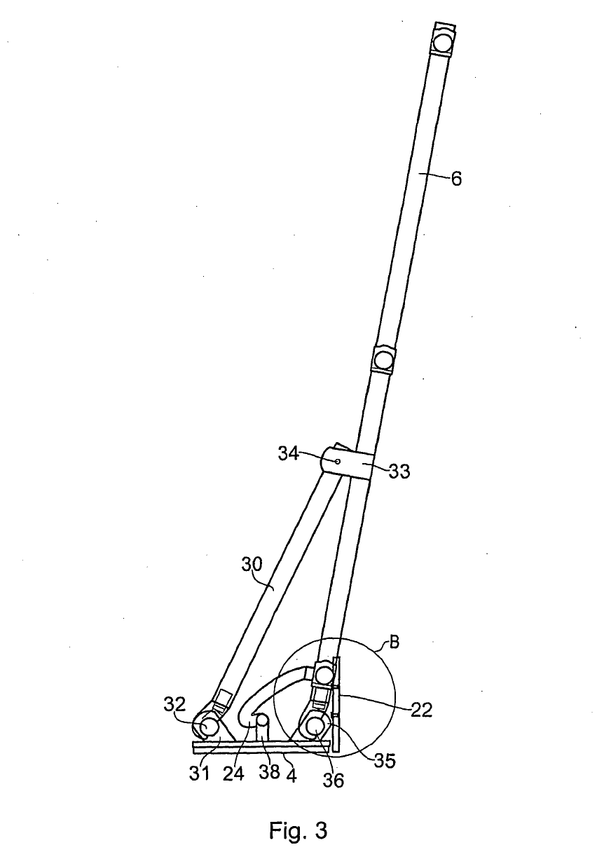

With reference to FIG. 3, a side view of the segregator barrier 2 is shown. The segregator barrier 2 further comprises a shock reducing element 30. A first end of the shock reducing element 30 is connected to the suction plate 4 via a first pivot point 32, whilst a second end of the shock reducing element 30 is connected to the support member 6 via a second pivot point 34. The first pivot point 32 is provided on a first projecting member 31 which protrudes from the suction plate 4. Similarly, the second pivot point 34 is provided on a second projecting member 33, which protrudes from the support member 6. The second projecting member 33 is preferably located between the first cross bar 8 and the second cross bar 10, although it may be located anywhere along the length of the support member 6. Furthermore, the support member 6 is connected to the suction plate via a third pivot point 36. The third pivot point 36 is provided on a third projecting member 35, which protrudes from the suction plate 4. The first projecting member 31 and third projecting member 35 are preferably placed at opposing ends of the suction plate 4. The suction plate 4 further comprises a connector 38, which provides a means for connecting the hosing 24 to the suction plate 4.

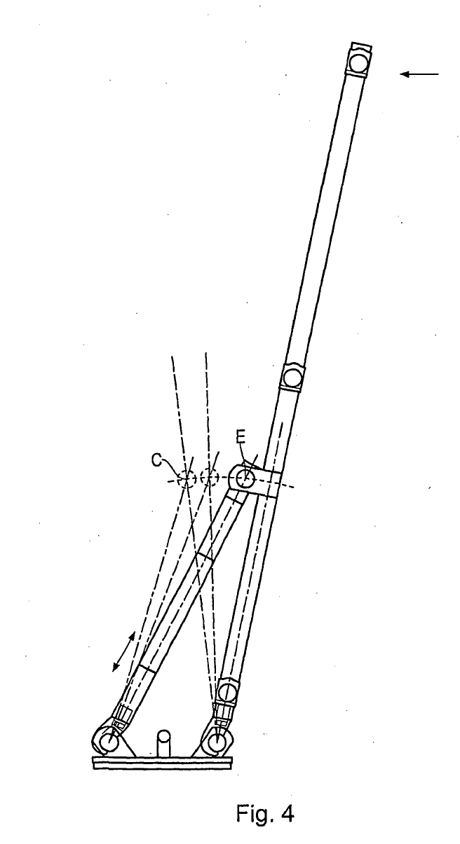

With reference to FIG. 4, a side view of the segregator barrier with varying positions for the support member 6 is shown. When the segregator barrier 2 is impacted in the direction shown by the single headed arrow, the support member 6 rotates about the third pivot point 36. The shock reducing element 30 is compressed as the second pivot point 34 moves from position E (extended) to position C (compressed). The effect of a shock load applied to the segregator barrier 2 can therefore be mitigated as the force transmitted to the suction plate 4 is reduced. Prior to impact, the barrier is preferably angled forward to prevent people leaning or placing equipment against it. The shock-reducing element 30 may comprise a resilient element and/or a damping element arrangement. The resilient element may consist of a spring and the damping element may consist of a dashpot. Alternatively, the shock reducing elements may comprise any suitable previously proposed shock absorber.

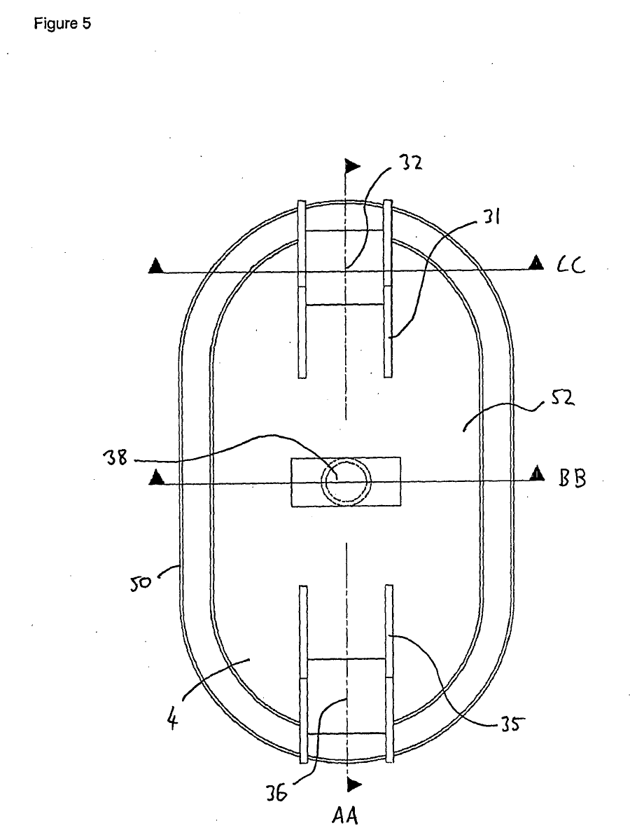

With reference to FIG. 5, the suction plate 4 further comprises a mounting plate 52 and a sidewall 50. The sidewall 50 acts as a seal and specifically may comprise a foam seal bonded to a hard rubber backing seal. The sidewall 50 rests on a surface (not shown) and provides a seal with the surface, thereby preventing ambient air from entering the suction plate 4. The mounting plate 52 provides a base for the first and third projecting members 31, 36 and the connector 38. A suction plate 4 embodying the present invention may be of size 350×250 mm.

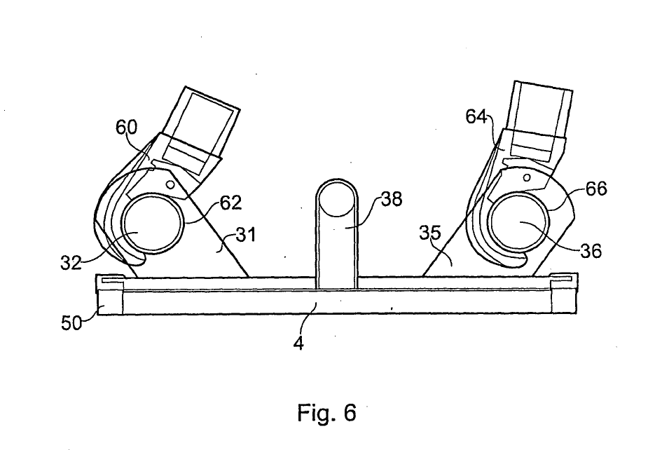

With reference to FIG. 6, which corresponds to section AA shown in FIG. 5, the first pivot point 32 further comprises a first hook 60 and a first sleeve 62. The first hook 60 is connected to an end of the shock-reducing element 30 and is adapted to fit around the first sleeve 62, which is provided on the first projecting member 31. Similarly, the third pivot point 36 comprises a second hook 64 and a second sleeve 66. The second hook 64 is connected to an end of the support member 6 and is adapted to fit around the second sleeve 66, which is provided on the third projecting member 35. A similar arrangement is provided for the second pivot point 34. The first and second hooks 60, 64 may comprise a securing means (not shown) and in a preferred embodiment, the first and second hooks 60, 64 may be standard scaffold type hooks with a spring loaded secure and release mechanism.

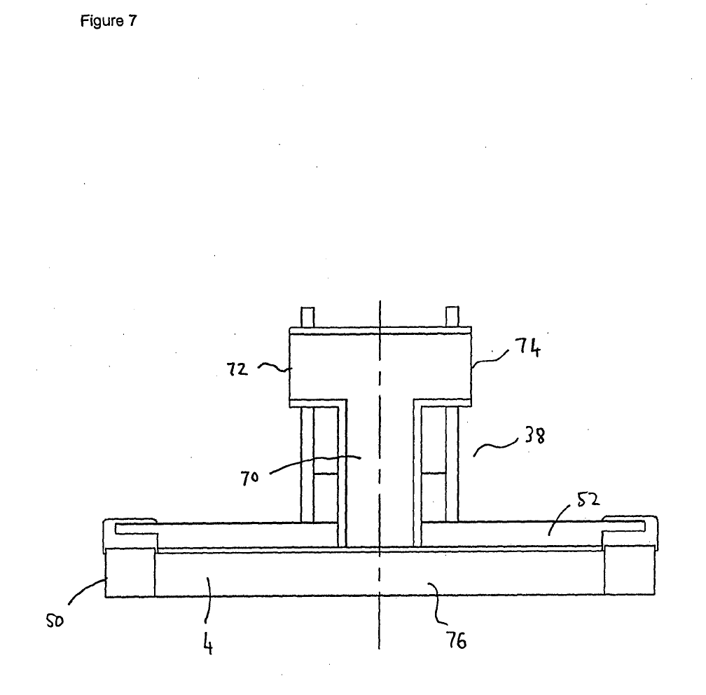

With reference to FIG. 7, which corresponds to section BB shown in FIG. 5, the suction plate 4 is further provided with a cavity 76. The cavity 76 is defined by the sidewalls 50, the mounting plate 52 and the surface to which the suction plate adheres. Furthermore, the connector 38 may comprise a passageway 70. The passageway 70 is in flow communication with the cavity 76 and first and second ports 72, 74. The first and second ports 72, 74 connect to the hosing 24, where the connection may be established by conventional means. The hosing 24 thereby connects successive suction plates in a daisy chain arrangement. In such an arrangement one end of the daisy chain would be connected to a vacuum source whilst the other end would be closed. The hosing 24 and connectors 38 therefore act as a manifold. The passageway 70 may further comprise a one-way flow valve (not shown). The one-way flow valve would allow a flow from the cavity 76 to either the first or second port 72, 74, but would not permit a flow in the opposite direction. Alternatively, a one way flow valve could be fitted to either the first or second port 72, 74. Furthermore, the passageway 70 may be provided with a reservoir (not shown), the reservoir being in flow communication with the passageway 70. The reservoir could provide an additional vacuum source in the event that the primary vacuum source should fail. The suction plate 4 may also be provided with a pressure sensor (not shown), where the pressure sensor may indicate a loss of vacuum.

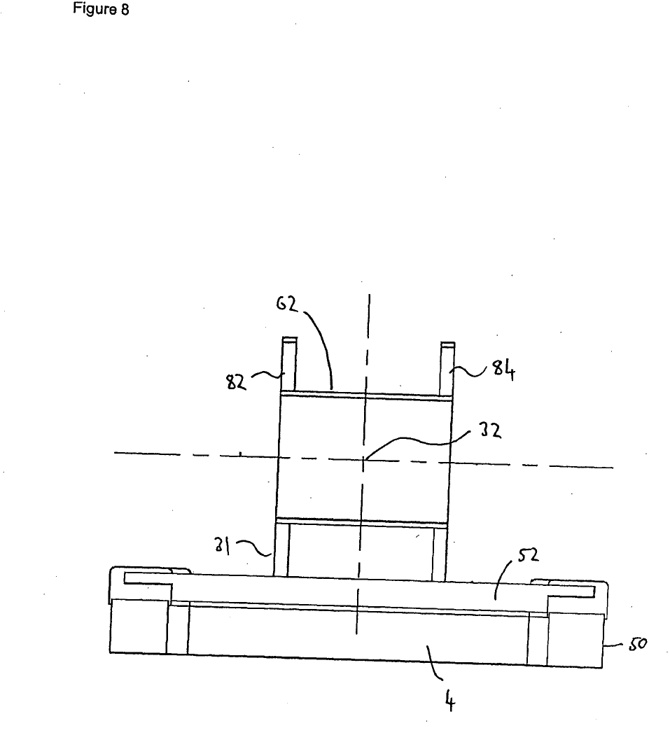

FIG. 8 shows a section through the first pivot point 32 and corresponds to section CC shown in FIG. 5. The first projecting member 31 is shown to comprise first and second projecting plates 82, 84, between which the first sleeve 62 is placed. In an alternative embodiment the first projecting member 31 may comprise just a first projecting plate to which the first sleeve 62 is attached. Furthermore, the first pivot point 32 may consist of other suitable previously proposed pivot mechanisms. The above-mentioned alternatives also apply to the third and second pivot points 36, 34.

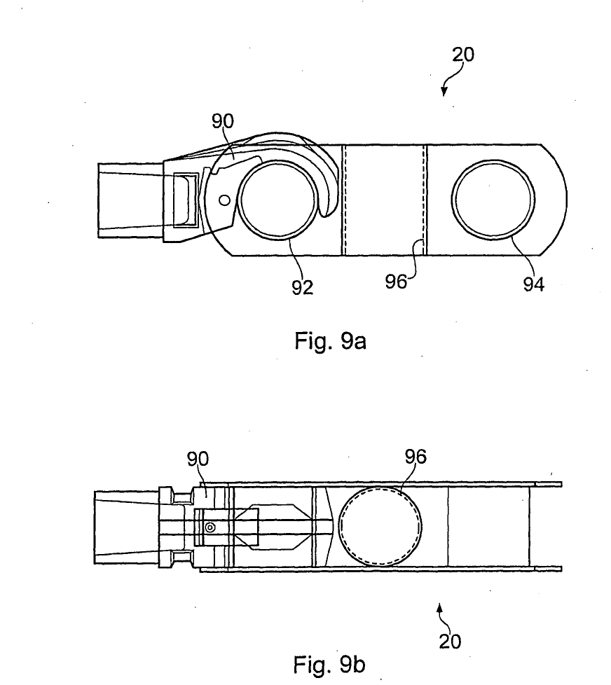

With reference to FIGS. 9a and 9b, which correspond to detail A shown in FIG. 2, the bracket 20 further comprises a fourth sleeve 92 and fifth sleeve 94. The fourth and fifth sleeves 92, 94 are adapted to receive a fourth hook 90 and a fifth hook (not shown). The fourth and fifth hooks are provided at ends of the first, second or third cross-bars 8, 10, 12. The bracket 20 therefore serves to join neighbouring cross bars. The bracket 20 is also provided with a channel 96. The channel 96 is adapted to receive the support member 6. A plurality of brackets 20 are provided on each support member 6 such that a plurality of cross-bars can be joined to each support member 6. In an alternative embodiment, the brackets 20 may be omitted and the fourth hook 90 and fifth hook may connect to the support member 6 directly.

The brackets 20 or fourth and fifth hooks may be held in place on the support member 6 by a collar (not shown) disposed about the perimeter of the support member 6. Such collars may be provided at various intervals along the length of the support member 6 corresponding to the desired locations for the cross-bars 8, 10, 12. Alternatively a pin or screw assembly passing through the support member 6 could hold each bracket 20 or fourth and fifth hooks in place. The fourth hook 90 and fifth hook may further comprise a securing means (not shown) and in a preferred embodiment, the fourth and fifth hooks may be standard scaffold type hooks with a spring loaded secure and release mechanism.

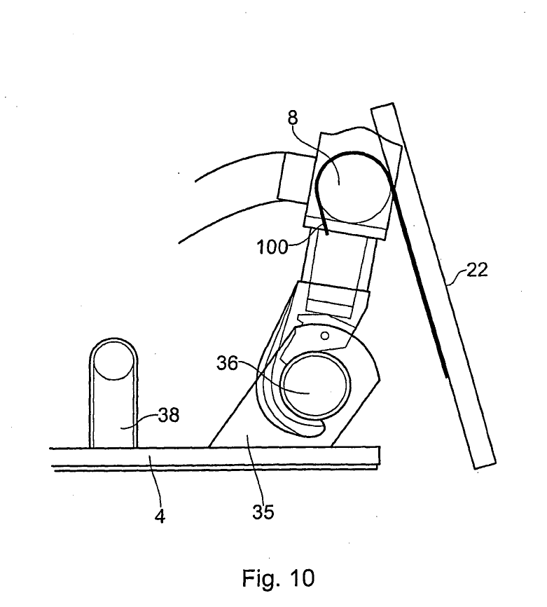

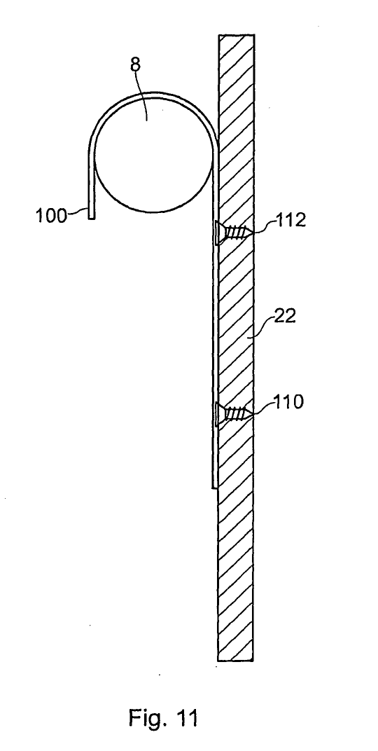

With reference to FIG. 10, which corresponds to detail B shown in FIG. 3, a cross section of the toe-board 22 is shown. The toe-board 22 further comprises a sixth hook 100, where the sixth hook 100 is adapted to fit onto the first cross-bar 8 and the toe-board 22 may be swingably attached to the first cross-bar 8. The toe-board 22 may be of sufficient length such that it reaches the surface of the floor and abuts the suction plate 4. The toe-board 22 may stop debris passing under the barrier or may prevent people from tripping on the suction plates 4. FIG. 11 provides further details of the toe-board 22 construction. The toe-board 22 may be fixed to the sixth hook 100 via first and second screws 110, 112. The sixth hook 100 and first and second screws 110,112 may be repeated at various intervals along the length of the toe-board which spans the width of the segregator barrier 2.

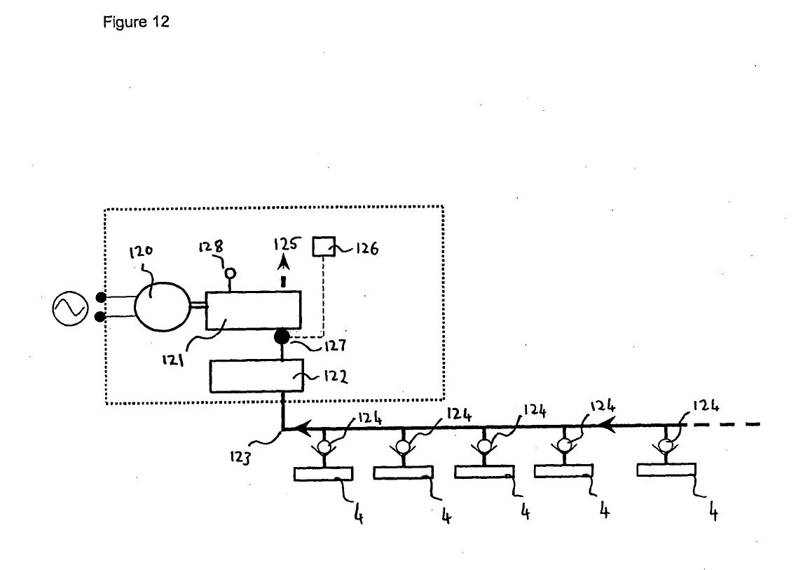

With reference to FIG. 12, the segregator barrier is connected when in use to a pump 121. The pump 121 acts as the vacuum source referred to earlier and pumps air from the suction plates 4 via a manifold 123 and vents the evacuated air through vent 125. The pump 121 is driven by a motor 120 which is powered by an electrical source. Alternatively, the pump 121 could be driven by any suitable previously proposed engine unit. Between the pump 121 and the manifold 123 there may also be provided a reservoir 122. In the event that the pump 121 may fail, the reservoir 122 will act as a vacuum source for a limited period of time. Furthermore, the reservoir 122 may act to smooth out any flow oscillations.

One-way flow valves 124 may be provided between the manifold and one or more of the suction plates 4. The one-way flow valves 124 are orientated to prevent the flow from the manifold to one or more of the suction plates 4. In this manner, if a suction plate 4 should fail, the incoming flow would not interfere with the vacuum in the remaining suction plates 4. Further one-way flow valves may be provided between the reservoir and the manifold and the pump and the reservoir.

The segregator barrier 2 may further comprise a fail-safe system. In particular, a pressure switch 127 may activate an alarm 126 when the pressure in the system reaches a threshold value. The alarm 126 may be audible and/or visible. Furthermore, one or more suction plates 4 may also be provided with a pressure switch that activates an alarm. Preferably, such alarms would emit a visible signal, but the signal may also be audible. The fail safe may also comprise means for detecting a loss of electrical power to the motor 120. A back up battery (not shown) may also be provided, the back up battery being arranged to provide the motor 120 with electrical power when a loss of electrical power is detected.

1-35. (canceled)

36. A segregator barrier comprising a barrier portion attached to a suction plate configured for adhering to a surface by the creation of a vacuum between the surface and the suction plate, the barrier being configured to mitigate the effect of a shock load applied to the barrier;
wherein the barrier comprises a shock-reducing element configured and operable for mitigating the effect of a shock load applied to the barrier;
wherein the shock-reducing element is provided between the barrier portion and the suction plate;
wherein a first end of the shock-reducing element is pivotally mounted on the suction plate; and
wherein a second end of the shock-reducing element is pivotally mounted on the barrier portion.

37. A segregator barrier according to claim 36, wherein the suction plate is configured to be operatively coupled to a vacuum source, and wherein a one-way flow valve is provided between the vacuum source and the suction plate.

38. A segregator barrier according to claim 36, wherein the suction plate is configured to be operatively coupled to a vacuum source, and wherein a vacuum reservoir is provided between the vacuum source and the suction plate.

39. A segregator barrier according to claim 37, wherein a manifold is provided between the vacuum source and the suction plate.

40. A segregator barrier according to claim 39, wherein the one-way flow valve is positioned between the manifold and the suction plate, and is orientated to prevent flow from the manifold to the suction plate.

41. A segregator barrier according to claim 39, wherein the one-way flow valve is positioned between the vacuum source and the manifold and is orientated to prevent flow from the vacuum source to the manifold.

42. A segregator barrier according to claim 39, wherein a vacuum reservoir is positioned between the manifold and the suction plate.

43. A segregator barrier according to claim 42, wherein the one-way flow valve is positioned between the manifold and the vacuum reservoir.

44. A segregator barrier according to claim 39, wherein a vacuum reservoir is positioned between the vacuum source and the manifold.

45. A segregator barrier according to claim 44, wherein the one-way flow valve is positioned between the vacuum source and the vacuum reservoir.

46. A segregator barrier according to any of the claims 42, 43, and 44, wherein the one-way flow valve is positioned between the vacuum reservoir and the manifold.

47. A segregator barrier according to claim 36, wherein the shock-reducing element comprises a resilient element.

48. A segregator barrier according to claim 36, wherein the shock-reducing element comprises a damping element.

49. A segregator barrier according to claim 36, wherein the barrier portion is pivotally mounted on the suction plate.

50. A segregator barrier according to claim 36, further comprising a vacuum source operatively coupled to the suction plate so as to apply a suction thereto, wherein the vacuum source comprises:
a pump driven by an electric motor; and
a fail-safe mechanism comprising a detector that is operable to detect a loss of electrical power to the electric motor.

51. A segregator barrier according to claim 50, wherein the fail-safe mechanism further comprises a back-up battery configured to provide the electric motor with electrical power when the fail-safe mechanism detects a loss of electrical power to the motor.

52. A segregator barrier according to claim 36, further comprising an alarm that is operable in response to a failure of the vacuum source.

53. A segregator barrier according to claim 36, further comprising an alarm that is operable in response to a loss of vacuum in the suction plate.
